(19) United States
(12) Patent Application Publication
(10) Pub. No.: US 2017/0350541 A1
(43) Pub. Date: Dec. 7, 2017

(54) LIGHT WEIGHT, HIGH PERFORMANCE TUBED FUEL LINE

(71) Applicant: ContiTech Techno-Chemie GmbH, Karben (DE)

(72) Inventor: Brian Henry, Sun Prairie, WI (US)

(73) Assignee: ContiTech Techno-Chemie GmbH, Karben (DE)

(21) Appl. No.: 15/171,307

(22) Filed: Jun. 2, 2016

(51) Int. Cl. F16L 11/08

(52) U.S. Cl. CPC F16L 11/085

(57) ABSTRACT

A hose includes an innermost tube formed of one or more of synthetic rubbers, fluorine polymers or combinations thereof, and a braided reinforcement layer formed of a first plurality and second plurality of flat yarns. The first plurality and second plurality of flat yarns are disposed in a one-over/one-under braiding pattern adjacent the innermost tube. An optional cover layer may be disposed outwardly adjacent the braided reinforcement layer. An optional tie layer or adhesive coating may in some cases, be disposed between the innermost tube and the braided reinforcement layer. In some other cases, the braided reinforcement layer is directly applied upon the innermost tube. The braided reinforcement layer may be formed of flat yarns containing continuous filaments that have not been twisted or textured, and may be filaments based upon thermoplastic polymers or liquid crystal polymers.

### FIELD

The field to which the disclosure generally relates is a light weight hose with low permeability to fuels, and more particularly to a hose with a reinforcing layer using particular types of untwisted yarns.

### BACKGROUND

This section provides background information to facilitate a better understanding of the various aspects of the disclosure. It should be understood that the statements in this section of this document are to be read in this light, and not as admissions of prior art.

Developments in the automotive industry have resulted in higher engine output and thus temperature conditions, more compact engine compartments, use of motor-vehicle fuels containing alcohol, as well as ongoing demand for lighter weight components. Performance requirements for fuel hoses used in automotive applications are thus subject to such demands.

Conventional fuel hose constructions used economical, fuel-resistant rubber materials such as nitrile rubber (NBR), nitrile-polyvinyl chloride blends (NBR-PVC), epichlorohydrin (ECO), Ethylene Acrylic Elastomer (AEM), and the like. Improved hose for alcohol-containing fuels now generally use one or more of various fluoroelastomers and/or fluoroplastics such as those commonly designated as FKM, PVDF, ETFE, FEP, EFEP, PCTFE, THV, PTFE, and the like (hereinafter referred to generally as fluoropolymers), to provide a barrier to alcohol and fuel permeation. Typical preferred materials for a fuel hose barrier layer, or innermost tube, include fluoropolymers such as FKM (fluoroelastomers containing vinylidene fluoride as a monomer) or THV (a terpolymer of tetrafluoroethylene, hexafluoropropylene, and vinylidene fluoride).

In some cases, conventional high temperature, low permeation fuel line hoses include a co-extruded FKM innermost tube, a reinforcing layer (or layers) and an outer rubber cover. The co-extruded tube consists of an FKM tube layer followed by a tie gum layer of less expensive rubber such as ECO or AEM. The reinforcing layer(s) is typically a single braid of aramid or polyester, or other suitable material, or two spiral plies of similar material separated by a layer of rubber. The cover compound can be suitable polymer, and commonly AEM is used. The hose is normally vulcanized in steam after sheathing or wrapping to obtain the required surface appearance. Some fuel line parts are also formed to specific shapes to assist in routing around the engine.

Some drawbacks to conventional fuel line hoses constructed using the materials described above include significant gauge or thickness, and thus weight of the hose, complexity in manufacturing using the multitude of layers, and often negative performance impact due to the requirement of a tie layer. As such, there is an ongoing need for fuel line hoses which overcome these and other drawbacks, such need met, at least in part, by embodiments according to the following disclosure.

### SUMMARY

This section provides a general summary of the disclosure, and is not a necessarily a comprehensive disclosure of its full scope or all of its features.

In a first aspect of the disclosure a hose includes an innermost tube formed of synthetic rubbers, fluorine polymers or combinations thereof, and a braided reinforcement layer formed of a first plurality of flat yarns and a second plurality of flat yarns. The first plurality of flat yarns and the second plurality of flat yarns are disposed in a one-over/one-under braiding pattern adjacent the innermost tube. An optional cover layer may be disposed outwardly adjacent the braided reinforcement layer. In some aspects, the innermost tube is formed from one or more fluorine polymers, such as a FKM fluoroelastomer. An optional tie layer or adhesive coating may in some cases, be disposed between the innermost tube and the braided reinforcement layer. In some other cases, the braided reinforcement layer is directly applied upon the innermost tube. The braided reinforcement layer may be formed of flat yarns containing continuous filaments that have not been twisted or textured, and may be filaments based upon thermoplastic polymers or liquid crystal polymers.

Hoses according to the disclosure may have an innermost tube with a radial thickness in the range of from 0.50 mm to 1.60 mm. In some other aspects, the braided reinforcement layer has a radial thickness in the range of from 0.50 mm to 1.20 mm. In yet other aspects, the hoses have a total radial wall thickness in the range of from 1.50 mm to 3.60 mm.

In another aspect of the disclosure a fuel line hose is provided which includes an innermost tube formed of synthetic rubbers, fluorine polymers or combinations thereof, and a braided reinforcement layer formed of a first plurality of flat yarns and a second plurality of flat yarns. The first plurality of flat yarns and second plurality of flat yarns may be disposed in a one-over/one-under braiding pattern directly upon the innermost tube. An optional cover layer may be disposed outwardly adjacent the braided reinforcement layer, while in some other aspects, the braided reinforcement layer defines the outer circumference of the hose.

Yet another aspect provides a fuel line hose system including at least one length of hose having an innermost tube and a braided reinforcement layer containing a first plurality of flat yarns and a second plurality of flat yarns. The first plurality of flat yarns and second plurality of flat yarns are disposed in a one-over/one-under braiding pattern directly upon the innermost tube. The system further includes a fuel tank fluidly connected with the at least one length of hose, and a fuel pump fluidly connected with the at least one length of hose. In some aspects, the fuel line hose system is used for both gasoline and diesel fuel applications.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIG. 1 is a fragmented perspective view of a fuel line hose, which is constructed according to one embodiment of the disclosure;

FIG. 2 is a fragmented perspective view of a fuel line hose, which is constructed according to another embodiment of the disclosure; and,

FIG. 3 is a schematic representation of a hose system employing embodiments of fuel line hoses according to the disclosure.

### DETAILED DESCRIPTION

The following description of the variations is merely illustrative in nature and is in no way intended to limit the scope of the disclosure, its application, or uses. The description and examples are presented herein solely for the purpose of illustrating the various embodiments of the disclosure and should not be construed as a limitation to the scope and applicability of the disclosure. While the compositions of the present disclosure are described herein as comprising certain materials, it should be understood that the composition could optionally comprise two or more chemically different materials. In addition, the composition can also comprise some components other than the ones already cited. In the summary of the disclosure and this detailed description, each numerical value should be read once as modified by the term “about” (unless already expressly so modified), and then read again as not so modified unless otherwise indicated in context. Also, in the summary of the disclosure and this detailed description, it should be understood that a concentration or amount range or dimension listed or described as being useful, suitable, or the like, is intended that any and every concentration or amount or dimension within the range, including the end points, is to be considered as having been stated. For example, “a range of from 1 to 10” is to be read as indicating each and every possible value along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors had possession of the entire range and all points within the range.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of concepts according to the disclosure. This description should be read to include one or at least one and the singular also includes the plural unless otherwise stated.

The terminology and phraseology used herein is for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited.

Also, as used herein any references to “one embodiment” or “an embodiment” means that a particular element, feature, structure, or characteristic described in connection with the embodiment is included in at least one embodiment. The appearances of the phrase “in one embodiment” in various places in the specification are not necessarily referring to the same embodiment.

Embodiments according to the disclosure are related to light weight hoses with low permeability to fuels, which incorporate reinforcing layer(s) using a an untwisted yarn, which may be substantially flat, and in some cases, of low denier. The untwisted yarns form a reinforcement layer by applying the untwisted yarns in a one-over/one-under braiding pattern. The untwisted yarns may be braided in such way as to form one reinforcement layer, or any of a plurality of separate reinforcement layers. In some aspects, the one-over/one-under braiding pattern of substantially flat untwisted yarns provides optimum, or even maximum coverage with minimal cover gauge, which in turn enables the hose to be vulcanized in open steam without sheathing or wrapping as well as producing a desired smooth finish. In some other aspects, use of such braid pattern enables some hose embodiments to be produced without a rubber cover.

Hoses in accordance with the disclosure generally include an innermost tube and at least one braided reinforcement layer. In some cases, an optional rubber cover outermost layer may be included as well. The radial thicknesses of the layers may be of any suitable dimension to provide a hose with desired properties. In some non-limiting aspects, the radial thickness of an innermost tube is in the range of from about 0.50 mm to about 1.60 mm; the radial thickness of a braided reinforcement layer is in the range of from about 0.50 mm to about 1.20 mm; and the total radial wall thickness of a hose is in the range of from about 1.50 mm to about 3.60 mm.

In some embodiments, no tie layer is disposed between the innermost tube and the braided reinforcement layer, or between a plurality of braided reinforcement layers, which in turn significantly reduces the amount of materials used, reduces the total wall gauge, reduces overall cost and also weight per unit length of hose. Also, elimination of the tie layer enables the hose to be manufactured with less process steps resulting in the use of less labor, less energy consumption and less capital resources. A further advantage gained by eliminating the conventional tie layer is improved performance since the poorer performing tie layer gum is not contained in the tube, and additionally, flame retarding properties are improved with incorporation of minimal fiber content. Further, in some embodiments of the disclosure, the same hose can be used for both gasoline and fuel, since conventionally, gasoline hoses utilize ECO tie gum layers, while diesel hoses normally utilize less expensive AEM tie gum layers; thus, elimination of the tie layer makes possible use of hoses for both gasoline and diesel fuel applications.

The innermost tube used in embodiments of the disclosure may be formed from one or more materials which provide a sufficiently low permeability barrier layer. Some nonlimiting examples of such materials include, but are not limited to, synthetic rubbers or fluorine polymers. Fluorine polymers are suitable since a fluorine polymer is considerably excellent in chemical resistance and heat resistance.

Some suitable examples of fluorine polymers suitable for the innermost tube include ethylene-tetrafluoroethylene copolymer (ETFE), polyvinylidene-fluoride (PVDF), polyvinyl fluoride (PVF), polychlorotrifluoroethylene (PCTFE), ethylene-chlorotrifluoroethylene copolymer (ECTFE), ethylene-tetrafluoroethylene-hexafluoropropylene copolymer, hexafluoropropylene-tetrafluoroethylene copolymer (FEP), polytetrafluoroethylene (PTFE), tetrafluoroethylene-perfluoroalkyl vinyl ether copolymer (PFA), tetrafluoroethylene-hexafluoropropylene-perfluoroalkyl ethylene terpolymer, vinylidene fluoride-tetrafluoroethylene copolymer, vinylidene fluoride-hexafluoropropylene copolymer, tetrafluoroethylene-hexafluoropropylene-vinylidene fluoride terpolymer (THV), hexafluoropropylene-perfluoroalkyl vinyl ether, vinylidene fluoride-chlorotrifluoroethylene copolymer, vinylidene fluoride-perfluoroalkyl vinyl ether, vinylidene fluoride-tetrafluoroethylene-perfluoroalkyl vinyl ether, vinylidene fluoride-hexafluoropropylene-perfluoroalkyl vinyl ether, ethylene-tetrafluoroethylene-perfluoroalkyl vinyl ether, ethylene-hexafluoropropylene-perfluoroalkyl vinyl ether, ethylene-tetrafluoroethylene-hexafluoropropylene-perfluoroalkyl vinyl ether, other FKM fluoroelastomers containing vinylidene fluoride as a monomer, and the like.

In some aspects, the innermost tube may also contain a thermoplastic polyester elastomer (TPEE), polybutylene terephthalate (PBT), polyphenylene sulfide (PPS), polyethylene (PE), polypropylene (PP), or an alloy material including any of these materials combined with the above fluorine polymer or synthetic rubber materials to provide sufficient conductivity, elasticity, shock resistance, and the like.

Hose embodiments according to the disclosure incorporate reinforcement layer(s) formed from flat yarns, which generally are yarns formed of continuous filaments that have not been twisted or textured. Filaments may be formed from any suitable synthetic or natural fiber, or combinations of synthetic and/or natural fibers. The flat yarns used in embodiments of the disclosure may have a denier of from about 500 to about 5000 and may, in some aspects, have a denier of from about 1000 to about 2000.

Some exemplary synthetic fibers include fibers based upon polyamide polymers (including polyaramid and nylon), polyester polymers, polyacrylic polymers, polyolefin polymers, polyvinyl alcohol (PVA), polyvinyl acetate, polyphenylene bezobisoxazole (PBO), and the like, or any blends thereof. From a morphology perspective, the polymers used to form synthetic fibers may be thermoplastic polymers or liquid crystal polymers. At temperatures well above the crystalline melting temperature, thermoplastic polymers tend to become disordered, viscous liquids. Liquid crystalline polymers, on the other hand, possess molecular orders that are retained in their viscous liquid state. Blends of synthetic and natural fibers may be useful as well. In some cases, the filament may be steel, such as stainless or galvanized, brass, zinc or zinc-plated, or other metal wire, or a blend thereof.

With respect to the one-over/one-under braiding pattern used for forming the reinforcement layer, or layers, from flat yarns, at least one, two or up to three or more braided reinforcement layers are provided over the innermost tube. For example, where one braided reinforcement layer is used, each of the flat yarns is braided over, or adjacent, the innermost tube over and under one another, and oppositely wound so as to counterbalance torsional twisting effects. Further where two braided reinforcement layers are used, the flat yarns forming the second braided reinforcement layer are braided upon the first braided reinforcement layer over and under one another, and so on. Multiple types of flat yarns may be used as well. For example, a first braided reinforcement layer may utilize flat yarns formed from a first type of continuous filaments, while a second braided reinforcement layer may utilize flat yarns formed from a second type of continuous filaments. Also, a flat yarn may include a plurality of types of continuous filaments within the flat yarn itself.

Reinforcement layers each may have a predetermined pitched angle θ relative the longitudinal axis of the hose. For typical applications, the pitch angle θ will be selected to be between about 45-63°, and particularly, may be selected depending upon the desired convergence of strength, elongation, weight, and volumetric expansion characteristics of the hose. In general, higher pitch angles above about 54.7° exhibit decreased radial expansion of the hose under pressure, but increased axial elongation. For high pressure applications, a “neutral” pitch angle of about 54.7° generally is preferred as minimizing elongation to about ±3% of the original hose length. Each reinforcement layer may be braided at the same or different absolute pitch angle, and it is known that the pitch angles of a braided reinforcement layer, or respective braided reinforcement layers, may be varied to affect the physical properties of the hose. In some constructions, however, the pitch angles of reinforcement layers are provided to about the same, but reversed. The tension and area coverage at which the reinforcement layers are braided may be varied to achieve the desired flexibility, which may be measured by bend radius, flexural forces, or the like, of the hose. The flat yarns generally will be applied at greater than about 50% coverage, greater than about 75% coverage, or even greater than about 90% coverage.

In hose embodiments which include an outer cover, the outermost reinforcement layer may be sheathed within one or more layers of a coaxially-surrounding protective cover having a circumferential interior surface and an opposing circumferential exterior surface, which defines the hose outer diameter. Depending upon its construction, the cover may be spray-applied, dip coated, cross-head or co-extruded, or otherwise conventionally extruded, spiral or longitudinally, i.e., “cigarette,” wrapped, or braided over the reinforcement layer, for example, a 0.01-0.15 inch (0.3-3.8 mm) thick layer of an abrasion-resistant thermoplastic, i.e., melt-processible, or thermosetting, vulcanizable natural rubber or a synthetic rubber such as fluoropolymer, chlorosulfonate, polybutadiene, butyl, neoprene, nitrile, polyisoprene, and buna-N, copolymer rubbers such as ethylene-propylene (EPR), ethylene-propylene-diene monomer (EPDM), nitrile-butadiene (NBR), HNBR, XNBR, CSM, CR, ECO, EVM, CPE, NBR-PVC, ethylene methylacrylate elastomer (EAM), acrylic or acrylate elastomer (ACM), or TPE, and styrene-butadiene (SBR), or blends such as ethylene or propylene-EPDM, EPR, or NBR, and copolymers and blends of any of the foregoing. The term “synthetic rubbers” also should be understood to encompass materials which alternatively may be classified broadly as thermoplastic or thermosetting elastomers such as polyurethanes, silicones, fluorosilicones, styrene-isoprene-styrene (SIS), and styrene-butadiene-styrene (SBS), as well as other polymers which exhibit rubber-like properties such as plasticized nylons, polyesters, ethylene vinyl acetates, and polyvinyl chlorides. As used herein, the term “elastomeric” is ascribed its conventional meaning of exhibiting rubber-like properties of compliancy, resiliency or compression deflection, low compression set, flexibility, and an ability to recover after deformation, i.e., stress relaxation. By “abrasion-resistant,” it is meant that such material for forming the cover may have a hardness of between about 60-98 Shore A durometer.

The materials used for forming the innermost tube layer and the cover layer (when used) of the hose may also contain various additives in conventional or suitable amounts known to persons having ordinary skill in the art. Such additives may include, and are not limited to retardants to prevent an unduly quick cure, antioxidants, processing aids, reinforcing agents and fillers, such as carbon black, silica, other mineral fillers, lignin, curing agents or systems, wetting agents or surfactants, plasticizers, processing oils, pigments, dispersants, dyes, and other colorants, opacifying agents, foaming or anti-foaming agents, anti-static agents, coupling agents such as titanates, chain extending oils, tackifiers, flow modifiers, pigments, lubricants, silanes, and other agents, stabilizers, emulsifiers, antioxidants, thickeners, and/or flame retardants. The formulation of the material may be compounded in a conventional mixing apparatus as an admixture of the rubber and filler components, and any additional fillers or additives.

The fuel line hoses may be manufactured using any suitable techniques know to those of skill in the art. In some embodiments, the innermost tube is formed from synthetic rubber or fluorine polymer by conventional extrusion with subsequent cooling and/or curing. If necessary, the tube may be cross-head extruded over a mandrel for support, or otherwise supported in later forming operations using air pressure and/or reduced processing temperatures. From the extruder, the inner tube may be delivered through a braider for applying the flat yarns to form the reinforcement layer(s), and the flat yarns are typically applied under tension. Optionally, a relatively thin bonding or other interlayer may be extruded or otherwise applied between reinforcement layers, to bond each layer to the next layer, where a plurality of reinforcement layers is used. Following the braiding of the reinforcement layer(s) and optional interlayer(s), an outer cover optionally may be applied. Such cover, which may be formed as a cross-head extrusion, a moisture-cured or solvent-based dipped coating, or a spiral-wound wrapping. Following the application of the cover, the hose construction may be heated to vulcanize or cure the layers and thereby consolidate the construction into an integral fuel line hose structure.

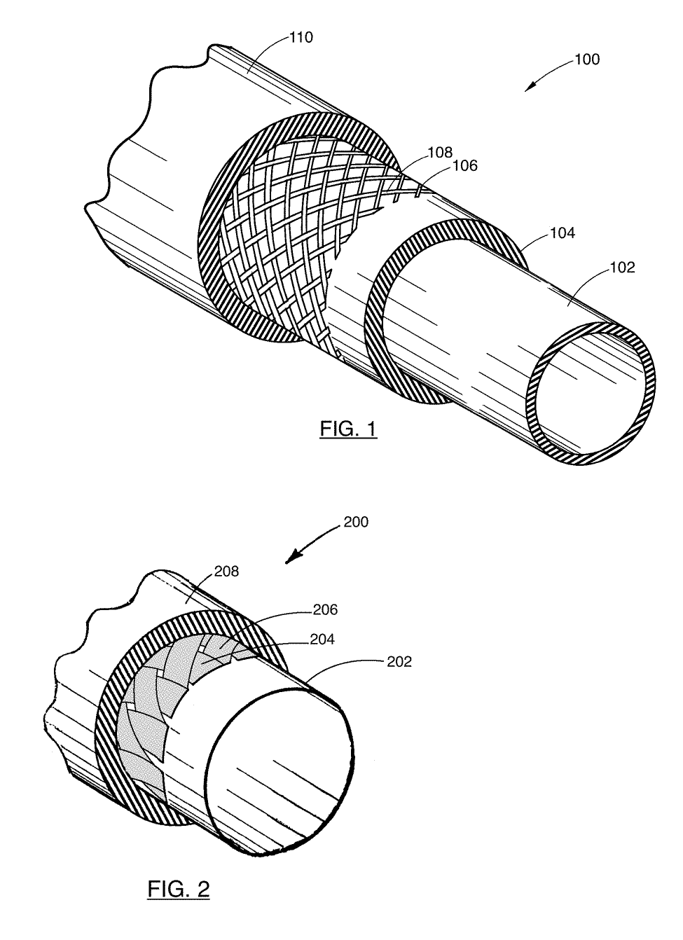

Now referencing FIG. 1, a fuel line hose is illustrated in a sectioned perspective view, which is constructed according to one embodiment of the disclosure. Hose 100 includes an innermost tube 102, an optional tie layer and/or adhesive coating 104, and a braided reinforcement layer formed of first flat yarns 106 (twelve shown), and second flat yarns 108 (eleven shown). Flat yarns 106 and 108 are disposed in the hose in a one-over/one-under braiding pattern, thus providing a braided reinforcement layer. Optionally, hose 100 may include an outer cover 110 defining the outer circumference of the hose. As another option, hose 100 may comprise one or more tie layers and/or adhesive coatings between various layers. FIG. 1 shows flat yarns 106 and 108 applied over optional tie layer and/or adhesive coating 104; however, flat yarns 106 and 108 may in some embodiments be applied directly over innermost tube 102, which is depicted in FIG. 2, as described below.

In the fuel line hose embodiment shown in FIG. 2 (a sectioned perspective view), hose 200 includes an innermost tube 202, and a braided reinforcement layer formed of first flat yarns 204 (five shown), and second flat yarns 206 (four shown). Here, also, flat yarns 204 and 206 are disposed in the hose in a one-over/one-under braiding pattern, thus providing a braided reinforcement layer. Further, hose 200 may optionally include an outer cover 208 as well as one or more tie layers and/or adhesive coatings between various layers.

The resulting hose according to one or more embodiments of the disclosure may advantageously be used, without limitation, for fuel line hoses as described, as well as for fuel vapor hose, vent hose for fuel or oil, air conditioning hose, propane or LP hose, curb pump hose, large inside diameter filler neck hose or tubing, marine fuel hose, fuel injection hose for fuels including gasoline, diesel, bio-diesel, and other oil-like fuels or blends of any of the foregoing, and the like.

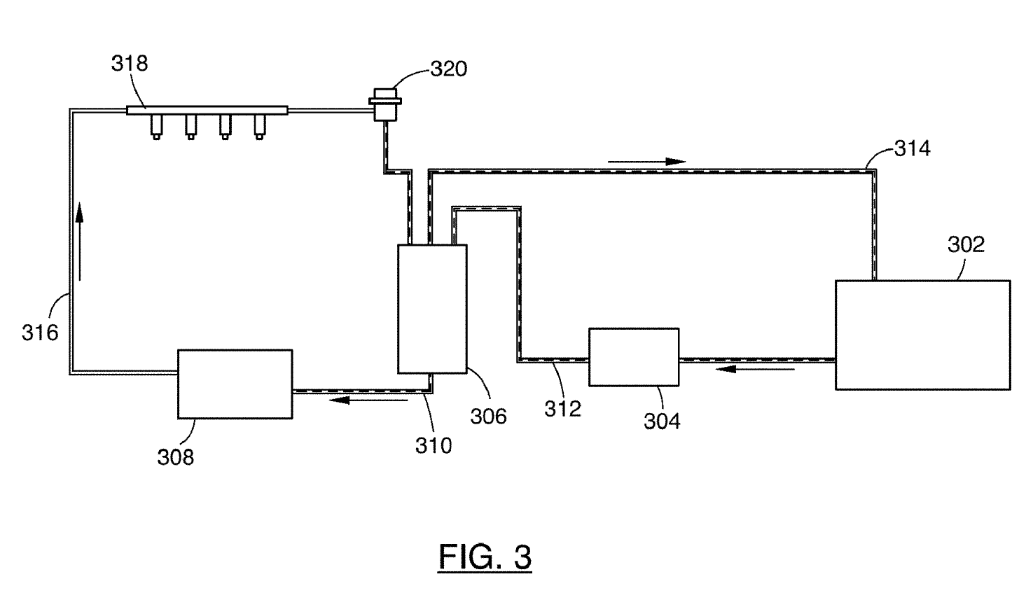

In operation, in one example, a fuel line hose may be a component of a hose assembly or a fuel line assembly or a fluid transfer system. A fluid transfer system generally includes a hose, and at one or more ends of the hose, one or more clamps, couplings, connectors, tubing, nozzles, and/or fittings, fluid handling devices, and the like. By way of example, FIG. 3 is a schematic representation of a hose system employing embodiments of fuel line hoses according to the disclosure. In particular, FIG. 3 represents a typical automotive fuel system. Referring to FIG. 3, fuel tank 302, fuel pump 304, surge tank or reservoir 306 and fuel pump 308 may be connected by one or more fuel hose sections such as 310 and 312 and others as applicable, which are provided by embodiments according to the disclosure. Fuel return line 314 may also include a section of hose according to the disclosure. Hose sections, such as 310, 312, and 314, may be of a low pressure construction employing embodiments of the disclosure. Medium or high pressure hose section 316, according to an embodiment of the disclosure, may be used to connect fuel pump 308 to fuel rail 318 with its injectors and to fuel pressure regulator 320. It should be understood that a fuel system utilizing the hose embodiments is not limited to automotive vehicle systems, but may include fuel transfer systems throughout the fuel supply chain, or fuel systems in marine applications, aviation, and the like, or anywhere else very low permeability flexible hose is desirable. For example, the hose embodiments of the disclosure may be also useful for transporting other fluids, including gases, including for example oxygen, hydrogen, or carbon dioxide, liquefied or gaseous propane or natural gas, other fuels, and refrigerants, and the like, with minimal permeation losses

The foregoing description of the embodiments has been provided for purposes of illustration and description. Example embodiments are provided so that this disclosure will be sufficiently thorough, and will convey the scope to those who are skilled in the art. Numerous specific details are set forth such as examples of specific components, devices, and methods, to provide a thorough understanding of embodiments of the disclosure, but are not intended to be exhaustive or to limit the disclosure. It will be appreciated that it is within the scope of the disclosure that individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Also, in some example embodiments, well-known processes, well-known device structures, and well-known technologies are not described in detail. Further, it will be readily apparent to those of skill in the art that in the design, manufacture, and operation of apparatus to achieve that described in the disclosure, variations in apparatus design, construction, condition, erosion of components, gaps between components may present, for example.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner”, “adjacent”, “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

1. A hose comprising:
an innermost tube comprising one or more of synthetic rubbers, fluorine polymers or combinations thereof;
a braided reinforcement layer comprising a first plurality of flat yarns and a second plurality of flat yarns; and,
a tie layer or adhesive coating disposed between the innermost tube and the braided reinforcement layer;
wherein the first plurality of flat yarns and second plurality of flat yarns are disposed in a one-over/one-under braiding pattern adjacent the innermost tube.

2. The hose of claim 1 further comprising a cover layer disposed outwardly adjacent the braided reinforcement layer.

3. The hose of claim 1 wherein the innermost tube comprises one or more fluorine polymers.

4. The hose of claim 3 wherein the innermost tube comprises a FKM fluoroelastomer.

5. (canceled)

6. (canceled)

7. The hose of claim 1 wherein the innermost tube has a radial thickness in the range of from 0.50 mm to 1.60 mm.

8. The hose of claim 1 wherein the braided reinforcement layer has a radial thickness in the range of from 0.50 mm to 1.20 mm.

9. The hose of claim 1 wherein the hose has a total radial wall thickness in the range of from 1.50 mm to 3.60 mm.

10. The hose of claim 1 wherein the braided reinforcement layer is formed of flat yarns comprising continuous filaments that have not been twisted or textured.

11. The hose of claim 10 wherein the flat yarns comprise continuous filaments based upon thermoplastic polymers.

12. The hose of claim 10 wherein the flat yarns comprise continuous filaments based upon liquid crystal polymers.

13. A fuel line hose comprising:
an innermost tube comprising one or more of synthetic rubbers, fluorine polymers or combinations thereof;
a braided reinforcement layer comprising a first plurality of flat yarns and a second plurality of flat yarns; and,
a tie layer or adhesive coating disposed between the innermost tube and the braided reinforcement layer;
wherein the first plurality of flat yarns and second plurality of flat yarns are disposed in a one-over/one-under braiding pattern directly upon the innermost tube.

14. The fuel line hose of claim 13 further comprising a cover layer disposed outwardly adjacent the braided reinforcement layer.

15. The fuel line hose of claim 13 wherein the braided reinforcement layer defines the outer circumference of the hose.

16. The fuel line hose of claim 13 wherein the innermost tube comprises a FKM fluoroelastomer.

17. The hose of claim 13 wherein the braided reinforcement layer is formed of flat yarns comprising continuous filaments that have not been twisted or textured, and wherein the continuous filaments based upon thermoplastic polymers.

18. The hose of claim 13 wherein the braided reinforcement layer is formed of flat yarns comprising continuous filaments that have not been twisted or textured, and wherein the continuous filaments based upon liquid crystal polymers.

19. The fuel line hose of claim 13 as used for both gasoline and diesel fuel applications.

20. A fuel line hose system comprising:
at least one length of hose comprising an innermost tube, a braided reinforcement layer comprising a first plurality of flat yarns and a second plurality of flat yarns, and a tie layer or adhesive coating disposed between the innermost tube and the braided reinforcement layer, wherein the first plurality of flat yarns and second plurality of flat yarns are disposed in a one-over/one-under braiding pattern directly upon the innermost tube;
a fuel tank fluidly connected with the at least one length of hose; and,
a fuel pump fluidly connected with the at least one length of hose;
wherein the fuel line hose system may be used for both gasoline and diesel fuel applications.
